(19) United States
(12) Patent Application Publication
(10) Pub. No.: US 2009/0278779 A1
(43) Pub. Date: Nov. 12, 2009

(54) LCD DEVICE BASED ON DUAL SOURCE DRIVERS WITH DATA WRITING SYNCHRONOUS CONTROL MECHANISM AND RELATED DRIVING METHOD

(76) Inventors: Yu-Jung Liu, Hsin-Chu (TW); Chun-Hung Kuo, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/189,767

(22) Filed: Aug. 11, 2008

(30) Foreign Application Priority Data
May 7, 2008 (TW) 097116807

(51) Int. Cl. G09G 3/36

(52) U.S. Cl. 345/98

(57) ABSTRACT

An LCD device having dual source drivers and related driving method are disclosed for performing data signal driving operation by making use of a data writing synchronous control mechanism. The operation of the data writing synchronous control mechanism includes furnishing all image data signals to both the first and second source drivers, latching odd and even image data signals by the first and second source drivers respectively, performing a signal processing process on the odd image data signals for generating a first set of analog data signals by the first source driver, performing a signal processing process on the even image data signals for generating a second set of analog data signals by the second source driver, writing the first set of analog data signals into a plurality of first pixel units, and writing the second set of analog data signals into a plurality of second pixel units.

### BACKGROUND OF THE INVENTION

1. Field of the Invention

The present invention relates to a liquid crystal display device and related driving method, and more particularly, to a liquid crystal display device based on dual source drivers with data writing synchronous control mechanism and related driving method.

2. Description of the Prior Art

Because liquid crystal display (LCD) devices are characterized by thin appearance, low power consumption, and low radiation, LCD devices have been widely applied in various electronic products for panel displaying. In general, the LCD device comprises liquid crystal cells encapsulated by two substrates and a backlight module for providing a light source. The operation of an LCD device is featured by varying voltage drops between opposite sides of the liquid crystal cells for twisting the angles of the liquid crystal molecules of the liquid crystal cells so that the transparency of the liquid crystal cells can be controlled for illustrating images with the aid of the backlight module.

It is well known that LCD devices perform data writing operations for writing data signals into a plurality of pixel units via a plurality of data lines under the control of a plurality of gate signals. Concerning an LCD device having low resolution, the width of each pixel unit is enough for wiring a corresponding data line so that all the data lines can be coupled to single source driver. However, concerning an LCD device having high resolution, the width of each pixel unit is not enough for wiring a corresponding data line, and therefore two source drivers are required to be disposed on opposite sides of the LCD panel of the LCD device for coupling odd data lines and even data lines respectively.

FIG. 1 is a schematic diagram showing a prior-art LCD device. As shown in FIG. 1, the LCD device 100 comprises a gate driver 110, a first source driver 120, a second source driver 150, an LCD panel 190, a data processing interface circuit 199, a plurality of gate lines GL1-GLm, and a plurality of data lines DL1-DLn. The gate driver 110 is coupled to the plurality of gate lines GL1-GLm for providing each gate line with a corresponding gate signal. The first source driver 120 is coupled to a plurality of odd data lines DL1, DL3-DLn−1 for providing each odd data line with a corresponding data signal. The second source driver 150 is coupled to a plurality of even data lines DL2, DL4-DLn for providing each even data line with a corresponding data signal.

The data processing interface circuit 199 performs the signal extracting and frequency down-converting processes on the image data signal Sdata received by the LCD device 100 for generating an odd data signal Sdata_odd and an even data signal Sdata_even. The odd data signal Sdata_odd and the even data signal Sdata_even are then forwarded to the first source driver 120 and the second source driver 150 respectively. That is, the first source driver 120 receives only the odd data signal Sdata_odd, and the second source driver 150 receives only the even data signal Sdata_even.

Consequently, the first source driver 120 performs signal processing operations only on the odd data signal Sdata_odd for generating corresponding data signals furnished to the plurality of odd data lines DL1, DL3-DLn−1, and the second source driver 150 performs signal processing operations only on the even data signal Sdata_even for generating corresponding data signals furnished to the plurality of even data lines DL2, DL4-DLn. Based on the above description, it is obvious that the data processing interface circuit is required to be installed in the prior-art LCD device for performing the signal extracting and frequency down-converting processes on the received image data signal prior to the signal processing operations of dual source drivers. However, as the resolution of the LCD panel is enhanced or the number of gray-scale levels of the image data signal is increased, the circuit design and layout of the data processing interface circuit will become more complicated in that more circuit units are required for performing the signal extracting and frequency down-converting processes in a desirable speed. In summary, the prior-art LCD device is required to provide more peripheral device area for installing the costly data processing interface circuit, and the power consumption in the operation of the prior-art LCD device is increased significantly due to the signal extracting and frequency down-converting processes.

### SUMMARY OF THE INVENTION

In accordance with an embodiment of the present invention, a liquid crystal display device based on dual source drivers with data writing synchronous control mechanism is provided. The liquid crystal display device comprises a first set of data lines, a second set of data lines, a plurality of gate lines, a gate driver, a first source driver, a second source driver, and a plurality of pixel units.

The first set of data lines is utilized for receiving a first set of data signals. The second set of data lines is utilized for receiving a second set of data signals. The plurality of gate lines is utilized for receiving a plurality of gate signals. The gate driver is coupled to the plurality of gate lines for providing the plurality of gate signals. The first source driver is coupled to the first set of data lines. The first source driver transfers the first set of data signals to the first set of data lines after receiving the first set of data signals and the second set of data signals. The second source driver is coupled to the second set of data lines. The second source driver transfers the second set of data signals to the second set of data lines after receiving the first set of data signals and the second set of data signals. Each pixel unit is coupled to a corresponding data line and a corresponding gate line.

In accordance with another embodiment of the present invention, a liquid crystal display device based on dual source drivers with data writing synchronous control mechanism is provided. The liquid crystal display device comprises a first set of data lines, a second set of data lines, a plurality of gate lines, a gate driver, a clock controller, a first source driver, a second source driver, and a plurality of pixel units.

The first set of data lines is utilized for receiving a first set of data signals. The second set of data lines is utilized for receiving a second set of data signals. The plurality of gate lines is utilized for receiving a plurality of gate signals. The gate driver is coupled to the plurality of gate lines for providing the plurality of gate signals. The clock controller is utilized for generating a first horizontal start signal, a first horizontal clock signal, a second horizontal start signal and a second horizontal clock signal based on a master clock signal, a horizontal synchronous signal or a vertical synchronous signal. The clock controller comprising a first output end for outputting the first horizontal start signal, a second output end for outputting the first horizontal clock signal, a third output end for outputting the second horizontal start signal, and a fourth output end for outputting the second horizontal clock signal. The first source driver is coupled to the first and second ends of the clock controller for receiving the first horizontal start signal and the first horizontal clock signal. Also, the first source driver is coupled to the first set of data lines for transferring the first set of data signals to the first set of data lines based on the first horizontal start signal and the first horizontal clock signal after receiving the first set of data signals and the second set of data signals. The second source driver is coupled to the third and fourth ends of the clock controller for receiving the second horizontal start signal and the second horizontal clock signal. Also, the second source driver is coupled to the second set of data lines for transferring the second set of data signals to the second set of data lines based on the second horizontal start signal and the second horizontal clock signal after receiving the first set of data signals and the second set of data signals. Each pixel unit is coupled to a corresponding data line and a corresponding gate line.

The present invention further provides a driving method for driving a liquid crystal display device having a first source driver and a second source driver. The driving method comprises: furnishing a plurality of data signals to the first source driver and the second source driver, wherein the plurality of data signals comprises a first set of data signals and a second set of data signals; transferring the first set of data signals to a plurality of first pixel units via the first source driver; and transferring the second set of data signals to a plurality of second pixel units via the second source driver.

Furthermore, the present invention provides a driving method for driving a liquid crystal display device having a first source driver and a second source driver. The driving method comprises: furnishing a plurality of data signals to the first source driver and the second source driver; generating a plurality of first control signals by the first source driver, and generating a plurality of second control signals by the second source driver; performing a data-overwrite latching process on a plurality of odd-order data signals of the data signals based on the plurality of first control signals by the first source driver; performing a data-overwrite latching process on a plurality of even-order data signals of the data signals based on the plurality of second control signals by the second source driver; performing a signal processing process on the plurality of odd-order data signals by the first source driver for generating a plurality of first analog data signals; performing a signal processing process on the plurality of even-order data signals by the second source driver for generating a plurality of second analog data signals; outputting the plurality of first analog signals to a plurality of first pixel units by the first source driver; and outputting the plurality of second analog signals to a plurality of second pixel units by the second source driver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a prior-art LCD device.

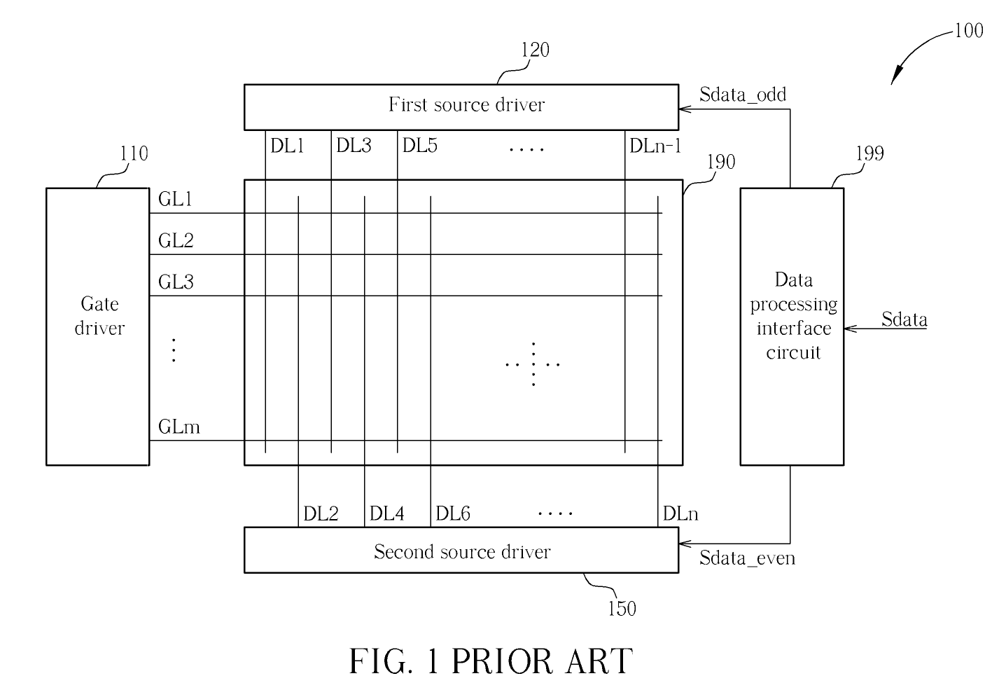

FIG. 2 is a schematic diagram showing an LCD device based on dual source drivers with data writing synchronous control mechanism in accordance with a first embodiment of the present invention.

FIG. 3 is a diagram schematically showing the structure of the first source driver in FIG. 2 in accordance with an embodiment of the present invention.

FIG. 4 is a diagram schematically showing the structure of the second source driver in FIG. 2 in accordance with an embodiment of the present invention.

FIG. 5 is a timing diagram schematically showing the related signal waveforms concerning the operation of the LCD device in FIG. 2, having time along the abscissa.

FIG. 6 is a schematic diagram showing an LCD device based on dual source drivers with data writing synchronous control mechanism in accordance with a second embodiment of the present invention.

FIG. 7 is a diagram schematically showing the structure of the first source driver in FIG. 6 in accordance with an embodiment of the present invention.

FIG. 8 is a diagram schematically showing the structure of the second source driver in FIG. 6 in accordance with an embodiment of the present invention.

FIG. 9 is a timing diagram schematically showing the related signal waveforms concerning the operation of the LCD device in FIG. 6, having time along the abscissa.

### DETAILED DESCRIPTION

Hereinafter, preferred embodiments of the present invention will be described in detail with reference to the accompanying drawings. Here, it is to be noted that the present invention is not limited thereto.

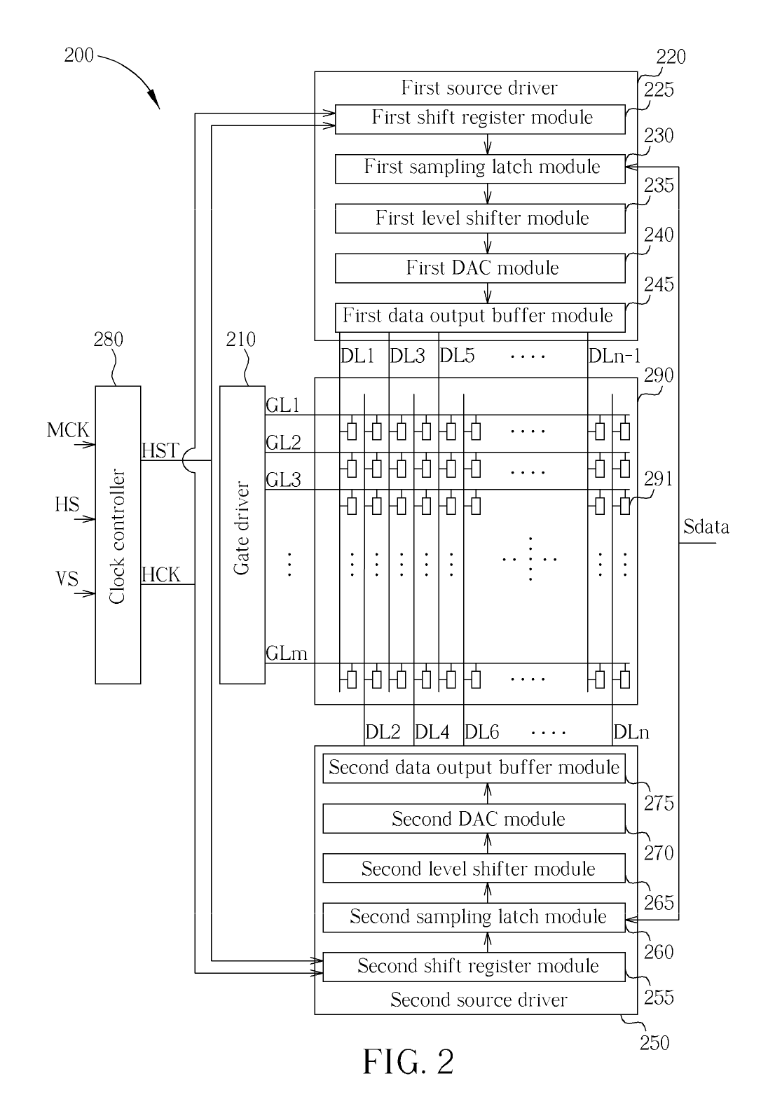

FIG. 2 is a schematic diagram showing an LCD device based on dual source drivers with data writing synchronous control mechanism in accordance with a first embodiment of the present invention. As shown in FIG. 2, the LCD device 200 comprises a gate driver 210, a first source driver 220, a second source driver 250, a clock controller 280, an LCD panel 290, a plurality of gate lines GL1-GLm, and a plurality of data lines DL1-DLn. The clock controller 280 is utilized for generating a horizontal start signal HST and a horizontal clock signal HCK based on a master clock signal MCK, a horizontal synchronization signal HS, or a vertical synchronization signal VS. The first source driver 220 and the second source driver 250 are coupled to the clock controller 280 for receiving the horizontal start signal HST and the horizontal clock signal HCK. The LCD panel 290 comprises a plurality of pixel units 291. Each pixel unit 291 is coupled to a corresponding gate line and a corresponding data line.

The first source driver 220 comprises a first shift register module 225, a first sampling latch module 230, a first level shifter module 235, a first digital-to-analog converter (DAC) module 240, and a first data output buffer module 245. The first shift register module 225 is utilized for generating a plurality of first control signals based on the horizontal start signal HST and the horizontal clock signal HCK. The first sampling latch module 230 is utilized for receiving the image data signal Sdata and latching the odd-order data signals of the image data signal Sdata based on the first control signals.

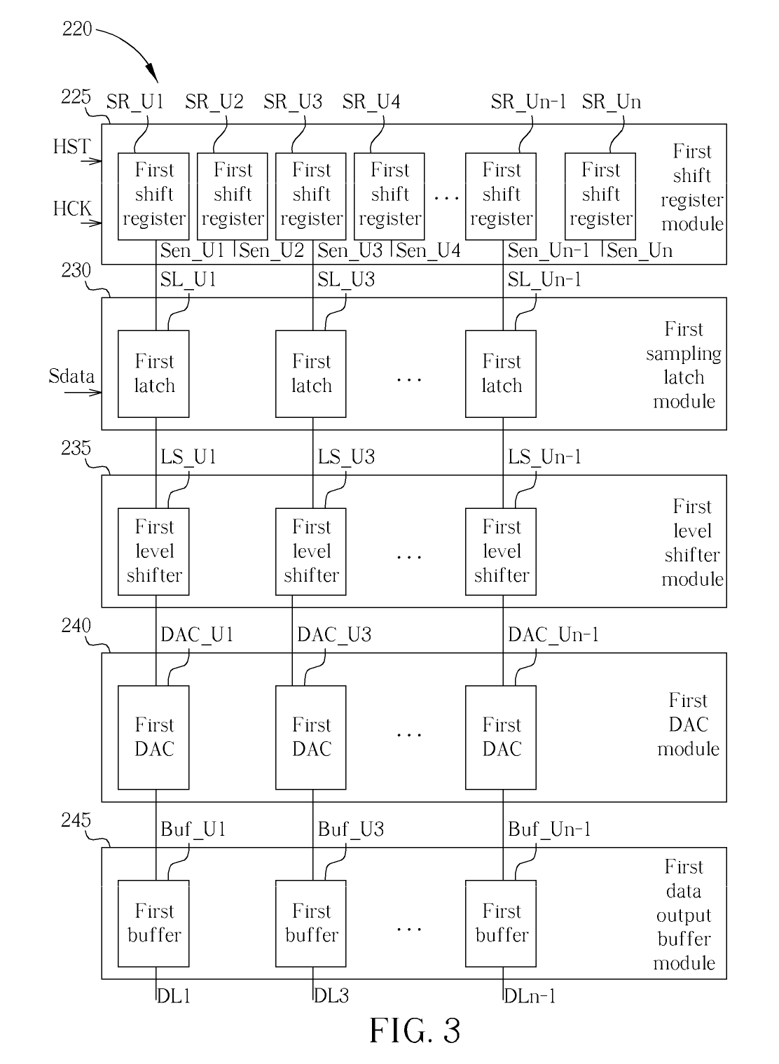

Referring to FIG. 3, there is shown a schematic diagram of the first source driver in FIG. 2 in accordance with an embodiment of the present invention. As shown in FIG. 3, the first shift register module 225 comprises a plurality of first shift registers SR_U1, SR_U2-SR_Un. The first sampling latch module 230 comprises a plurality of first latches SL_U1, SL_U3-SL_Un−1. The first level shifter module 235 comprises a plurality of first level shifters LS_U1, LS_U3-LS_Un−1. The first digital-to-analog converter module 240 comprises a plurality of first digital-to-analog converters DAC_UL, DAC_U3-DAC_Un−1. The first data output buffer module 245 comprises a plurality of first buffers Buf_U1, Buf_U3-Buf_Un−1.

Each first shift register is utilized for generating a corresponding first control signal. Each first shift register having odd-order is coupled directly to a corresponding first latch for providing a corresponding first control signal to the corresponding first latch. For instance, the first shift register SR_U1 having first-order is coupled directly to the first latch SL_U1 for providing the first control signal Sen_U1 to the first latch SL_U1, and the first shift register SR_U3 having third-order is coupled directly to the first latch SL_U3 for providing the first control signal Sen_U3 to the first latch SL_U3. The first shift registers having even-order are not coupled directly to any first latch. That is, the plurality of first control signals Sen_U2, Sen_U4-Sen_Un generated by the first shift registers having even-order are not forwarded to any first latch. Therefore, the first sampling latch module 230 fetches only odd-order data signals of the received image data signal Sdata. It is noted that the number of the first latches is substantially only a half of the number of the first shift registers in the embodiment shown in FIG. 3.

Each first level shifter is coupled to one corresponding first latch for performing a level shifting process on the corresponding odd-order data signal of the image data signal Sdata. Each first digital-to-analog converter is coupled to one corresponding first level shifter for performing a digital-to-analog converting process on the corresponding odd-order data signal of the image data signal Sdata. Each first buffer is coupled to one corresponding first digital-to-analog converter for performing a data output buffering process on the corresponding odd-order data signal of the image data signal Sdata. Also, each first buffer is coupled to one corresponding odd data line. For instance, the first buffer Buf_U1 is coupled between the first digital-to-analog converter DAC_U1 and the odd data line DL1, and the first buffer Buf_U3 is coupled between the first digital-to-analog converter DAC_U3 and the odd data line DL3.

The second source driver 250 comprises a second shift register module 255, a second sampling latch module 260, a second level shifter module 265, a second digital-to-analog converter module 270, and a second data output buffer module 275. The second shift register module 255 is utilized for generating a plurality of second control signals based on the horizontal start signal HST and the horizontal clock signal HCK. The second sampling latch module 260 is utilized for receiving the image data signal Sdata and latching the even-order data signals of the image data signal Sdata based on the second control signals.

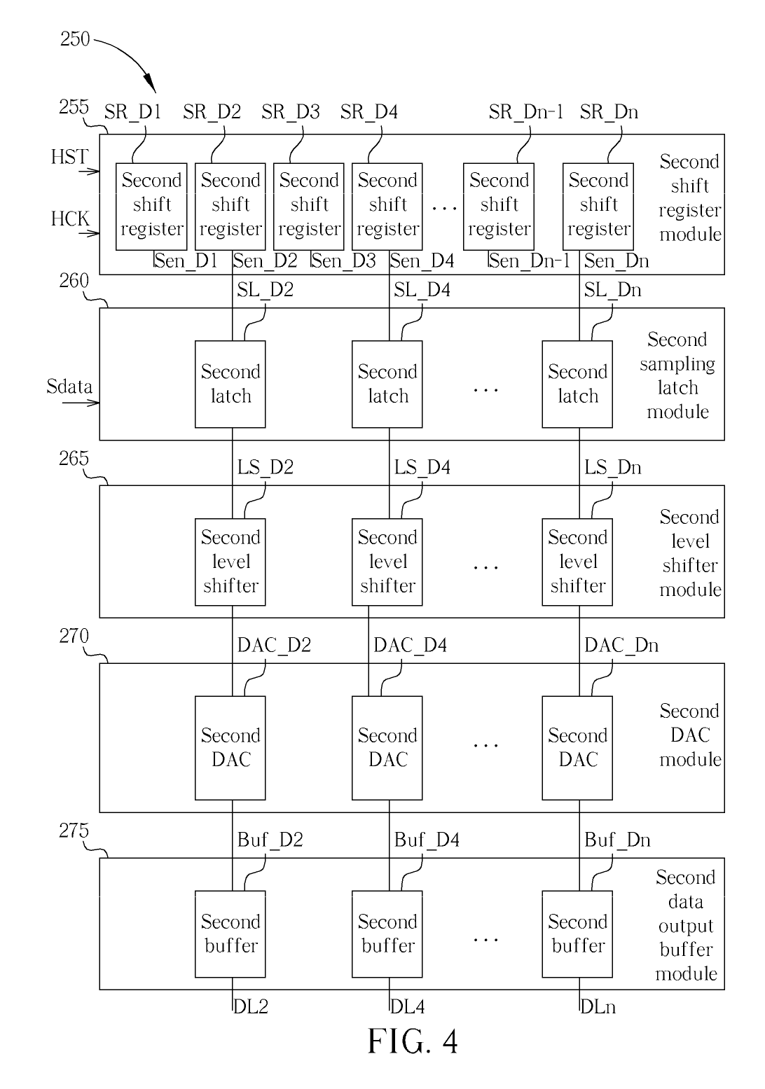

Referring to FIG. 4, there is shown a schematic diagram of the second source driver in FIG. 2 in accordance with an embodiment of the present invention. As shown in FIG. 4, the second shift register module 255 comprises a plurality of second shift registers SR_D1, SR_D2-SR_Dn. The second sampling latch module 260 comprises a plurality of second latches SL_D2, SL_D4-SL_Dn. The second level shifter module 265 comprises a plurality of second level shifters LS_D2, LS_D4-LS_Dn. The second digital-to-analog converter module 270 comprises a plurality of second digital-to-analog converters DAC_D2, DAC_D4-DAC_Dn. The second data output buffer module 275 comprises a plurality of second buffers Buf_D2, Buf_D4-Buf_Dn.

Each second shift register is utilized for generating a corresponding second control signal. Each second shift register having even-order is coupled directly to a corresponding second latch for providing a corresponding second control signal to the corresponding second latch. For instance, the second shift register SR_D2 having second-order is coupled directly to the second latch SL_D2 for providing the second control signal Sen_D2 to the second latch SL_D2, and the second shift register SR_D4 having fourth-order is coupled directly to the second latch SL_D4 for providing the second control signal Sen_D4 to the second latch SL_D4. The second shift registers having odd-order are not coupled directly to any second latch. That is, the plurality of second control signals Sen_D1, Sen_D3-Sen_Un−1 generated by the second shift registers having odd-order are not forwarded to any second latch. Therefore, the second sampling latch module 260 fetches only even-order data signals of the received image data signal Sdata. It is noted that the number of the second latches is substantially only a half of the number of the second shift registers in the embodiment shown in FIG. 4.

Each second level shifter is coupled to one corresponding second latch for performing a level shifting process on the corresponding even-order data signal of the image data signal Sdata. Each second digital-to-analog converter is coupled to one corresponding second level shifter for performing a digital-to-analog converting process on the corresponding even-order data signal of the image data signal Sdata. Each second buffer is coupled to one corresponding second digital-to-analog converter for performing a data output buffering process on the corresponding even-order data signal of the image data signal Sdata. Also, each second buffer is coupled to one corresponding even data line. For instance, the second buffer Buf_D2 is coupled between the second digital-to-analog converter DAC_D2 and the even data line DL2, and the second buffer Buf_D4 is coupled between the second digital-to-analog converter DAC_D4 and the even data line DL4.

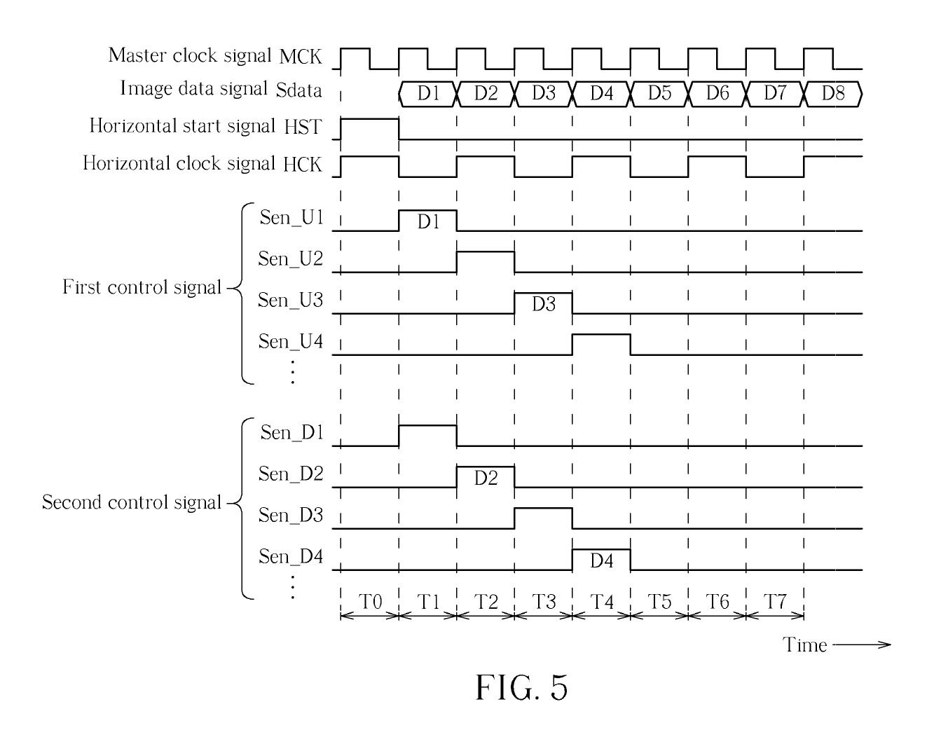

FIG. 5 is a timing diagram schematically showing the related signal waveforms concerning the operation of the LCD device in FIG. 2, having time along the abscissa. The signal waveforms in FIG. 5, from top to bottom, are the master clock signal MCK, the image data signal Sdata, the horizontal start signal HST, the horizontal clock signal HCK, the plurality of first control signals, and the plurality of second control signals. The image data signal Sdata comprises a plurality of data signals D1, D2, D3, etc. After a start pulse of the horizontal start signal HST is furnished to both the first shift register module 225 and the second shift register module 255 during the time T0, the first control signals and the second control signals are sequentially enabled based on the horizontal clock signal HCK. Each enable period of the first and second control signals is corresponding to a half period of the horizontal clock signal HCK.

For instance, the first shift register SR_U1 and the second shift register SR_D1 forward the enabled first control signal Sen_U1 and the enabled second control signal Sen_D1 respectively during the time T1, the first shift register SR_U2 and the second shift register SR_D2 forward the enabled first control signal Sen_U2 and the enabled second control signal Sen_D2 respectively during the time T2, the first shift register SR_U3 and the second shift register SR_D3 forward the enabled first control signal Sen_U3 and the enabled second control signal Sen_D3 respectively during the time T3, the first shift register SR_U4 and the second shift register SR_D4 forward the enabled first control signal Sen_U4 and the enabled second control signal Sen_D4 respectively during the time T4, and similar operations during other times can be inferred accordingly.

Based on the aforementioned structure of the LCD device 200, only the first shift registers having odd-order are coupled directly to the corresponding first latches, and therefore only the first control signals Sen_U1, Sen_U3-Sen_Un−1 generated by the first shift registers having odd-order can be forwarded to the corresponding first latches for performing data latching operations on the image data signal Sdata. That is, only odd-order data signals of the image data signal Sdata can be latched in the plurality of first latches SL_U1, SL_U3-SL_Un−1. Accordingly, as shown in FIG. 5, when the first control signals Sen_U1 and Sen_U3 are enabled during the times T1 and T3 respectively, the first latches SL_U1 and SL_U3 are able to latch the odd-order data signals D1 and D3 respectively. When the first control signals Sen_U2 and Sen_U4 are enabled during the times T2 and T4 respectively, the enabled first control signals Sen_U2 and Sen_U4 are not forwarded to any first latch for performing data latching operations. In other words, the enabled first control signals Sen_U2 and Sen_U4 are non-functional.

After the odd-order data signals are latched, the plurality of first level shifters LS_U1, LS_U3-LS_Un−1 perform level shifting operations on the odd-order data signals, and the plurality of first digital-to-analog converters DAC_UL, DAC_U3-DAC_Un−1 perform digital-to-analog converting operations on the odd-order data signals for generating a plurality of first analog data signals. The first analog data signals are then forwarded to the odd data lines DL1, DL3-DLn−1 respectively via the first buffers Buf_U1, Buf_U3-Buf_Un−1 so that the first analog data signals can be written into corresponding pixel units 291.

Besides, only the second shift registers having even-order are coupled directly to the corresponding second latches, and therefore only the second control signals Sen_D2, Sen_D4-Sen_Dn generated by the second shift registers having even-order can be forwarded to the corresponding second latches for performing data latching operations on the image data signal Sdata. That is, only even-order data signals of the image data signal Sdata can be latched in the plurality of second latches SL_D2, SL_D4-SL_Dn. Accordingly, as shown in FIG. 5, when the second control signals Sen_D2 and Sen_D4 are enabled during the times T2 and T4 respectively, the second latches SL_D2 and SL_D4 are able to latch the even-order data signals D2 and D4 respectively. When the second control signals Sen_D1 and Sen_D3 are enabled during the times T1 and T3 respectively, the enabled second control signals Sen_D1 and Sen_D3 are not forwarded to any first latch for performing data latching operations. In other words, the enabled second control signals Sen_D1 and Sen_D3 are non-functional.

After the even-order data signals are latched, the plurality of second level shifters LS_D2, LS_D4-LS_Dn perform level shifting operations on the even-order data signals, and the plurality of second digital-to-analog converters DAC_D2, DAC_D4-DAC_Dn perform digital-to-analog converting operations on the even-order data signals for generating a plurality of second analog data signals. The second analog data signals are then forwarded to the even data lines DL2, DL4-DLn respectively via the second buffers Buf_D2, Buf_D4-Buf_Dn so that the second analog data signals can be written into corresponding pixel units 291.

In summary, the costly data processing interface circuit is not required to be installed in the peripheral device area of the LCD device 200 of the present invention. That is, the input image data signal can be forwarded directly to both the first source driver 220 and the second source driver 250 for performing data writing operations without the aid of the data processing interface circuit. Accordingly, the LCD device 200 can be scaled down by reducing the peripheral device area, and furthermore the power consumption concerning the signal extracting and frequency down-converting processes can be put away in the operation of the LCD device 200.

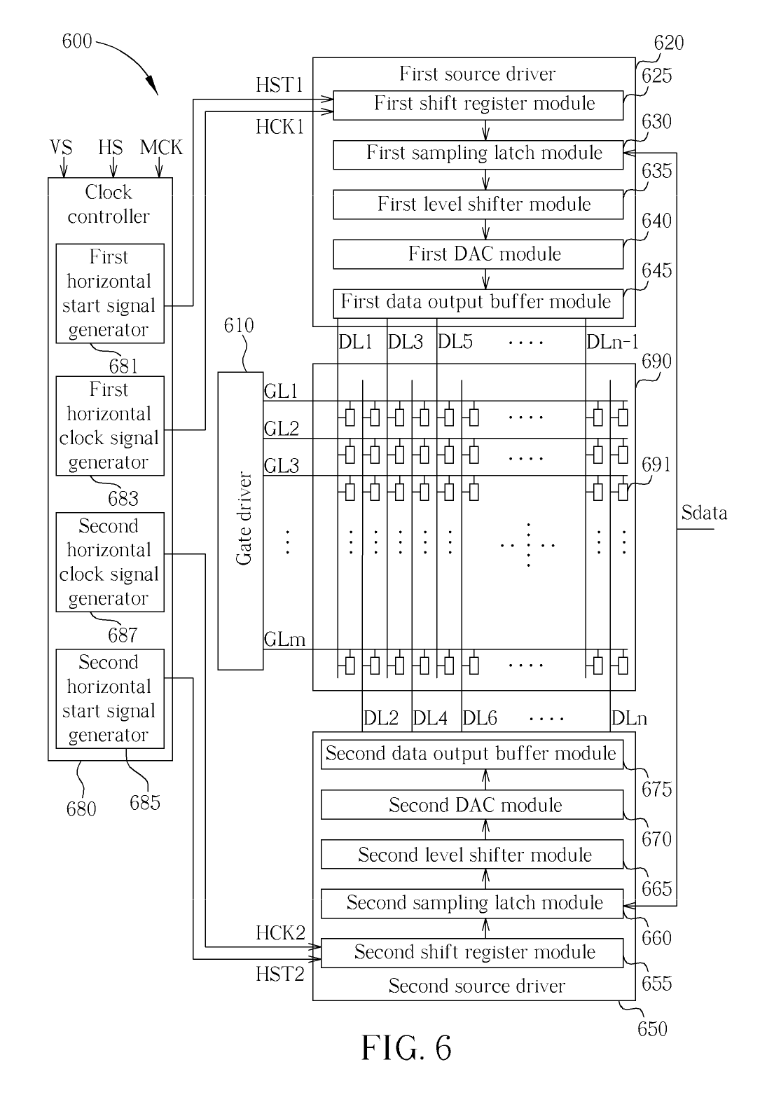

FIG. 6 is a schematic diagram showing an LCD device based on dual source drivers with data writing synchronous control mechanism in accordance with a second embodiment of the present invention. As shown in FIG. 6, the LCD device 600 comprises a gate driver 610, a first source driver 620, a second source driver 650, a clock controller 680, an LCD panel 690, a plurality of gate lines GL1-GLm, and a plurality of data lines DL1-DLn. The clock controller 680 is utilized for generating a first horizontal start signal HST1, a first horizontal clock signal HCK1, a second horizontal start signal HST2, and a second horizontal clock signal HCK2 based on a master clock signal MCK, a horizontal synchronization signal HS, or a vertical synchronization signal VS. The first source driver 620 is coupled to the first and second output ends of the clock controller 680 for receiving the first horizontal start signal HST1 and the first horizontal clock signal HCK1 respectively. The second source driver 650 is coupled to the third and fourth output ends of the clock controller 680 for receiving the second horizontal start signal HST2 and the second horizontal clock signal HCK2 respectively. The LCD panel 690 comprises a plurality of pixel units 691. Each pixel unit 691 is coupled to a corresponding gate line and a corresponding data line.

The clock controller 680 comprises a first horizontal start signal generator 681 for generating the first horizontal start signal HST1, a first horizontal clock signal generator 683 for generating the first horizontal clock signal HCK1, a second horizontal start signal generator 685 for generating the second horizontal start signal HST2, and a second horizontal clock signal generator 687 for generating the second horizontal clock signal HCK2. The circuits of the first horizontal start signal generator 681, the first horizontal clock signal generator 683, the second horizontal start signal generator 685, and the second horizontal clock signal generator 687 may be partly overlapped.

The first source driver 620 comprises a first shift register module 625, a first sampling latch module 630, a first level shifter module 635, a first digital-to-analog converter module 640, and a first data output buffer module 645. The first shift register module 625 is utilized for generating a plurality of first control signals based on the first horizontal start signal HST1 and the first horizontal clock signal HCK1. The first sampling latch module 630 is utilized for receiving the image data signal Sdata and performing a data-overwrite latching process for latching the odd-order data signals of the image data signal Sdata based on the first control signals.

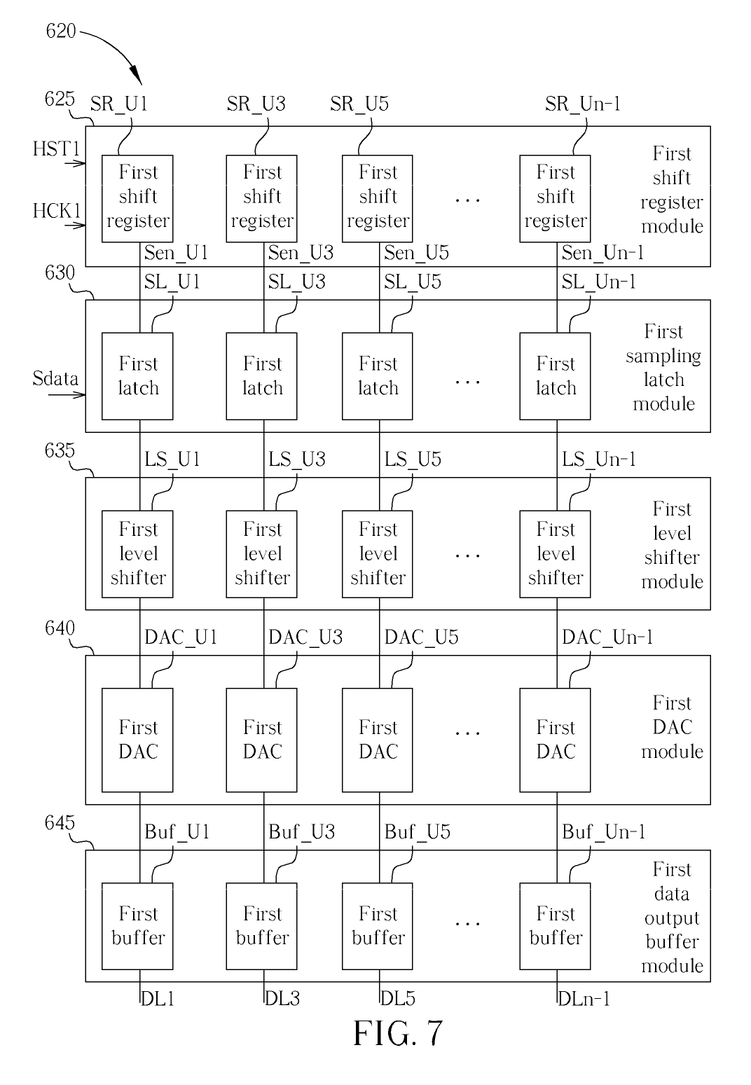

Referring to FIG. 7, there is shown a schematic diagram of the first source driver in FIG. 6 in accordance with an embodiment of the present invention. As shown in FIG. 7, the first shift register module 625 comprises a plurality of first shift registers SR_U1, SR_U3-SR_Un−1. The first sampling latch module 630 comprises a plurality of first latches SL_UL, SL_U3-SL_Un−1. The first level shifter module 635 comprises a plurality of first level shifters LS_UL, LS_U3-LS_Un−1. The first digital-to-analog converter 640 comprises a plurality of first digital-to-analog converters DAC_UL, DAC_U3-DAC_Un−1. The first data output buffer module 645 comprises a plurality of first buffers Buf_U1, Buf_U3-Buf_Un−1.

Each first shift register is utilized for generating a corresponding first control signal. Each first shift register is coupled directly to a corresponding first latch for providing a corresponding first control signal to the corresponding first latch. For instance, the first shift register SR_U1 is coupled directly to the first latch SL_U1 for providing the first control signal Sen_U1 to the first latch SL_U1, and the first shift register SR_U3 is coupled directly to the first latch SL_U3 for providing the first control signal Sen_U3 to the first latch SL_U3. It is noted that the number of the first latches is substantially equal to the number of the first shift registers in the embodiment shown in FIG. 7. In the latching operation corresponding to each first latch of the first sampling latch module 630, two consecutive data signals are sequentially latched during an enable period of the first control signal, and the firstly-latched data signal is overwritten by the secondly-latched data signal so that only the odd-order data signals of the image data signal Sdata are latched and the even-order data signals of the image data signal Sdata are overwritten.

Each first level shifter is coupled to one corresponding first latch for performing a level shifting process on the corresponding odd-order data signal of the image data signal Sdata. Each first digital-to-analog converter is coupled to one corresponding first level shifter for performing a digital-to-analog converting process on the corresponding odd-order data signal of the image data signal Sdata. Each first buffer is coupled to one corresponding first digital-to-analog converter for performing a data output buffering process on the corresponding odd-order data signal of the image data signal Sdata. Also, each first buffer is coupled to one corresponding odd data line. For instance, the first buffer Buf_U1 is coupled between the first digital-to-analog converter DAC_U1 and the odd data line DL1, and the first buffer Buf_U3 is coupled between the first digital-to-analog converter DAC_U3 and the odd data line DL3.

The second source driver 650 comprises a second shift register module 655, a second sampling latch module 660, a second level shifter module 665, a second digital-to-analog converter module 670, and a second data output buffer module 675. The second shift register module 655 is utilized for generating a plurality of second control signals based on the second horizontal start signal HST2 and the second horizontal clock signal HCK2. The second sampling latch module 660 is utilized for receiving the image data signal Sdata and performing a data-overwrite latching process for latching the even-order data signals of the image data signal Sdata based on the second control signals.

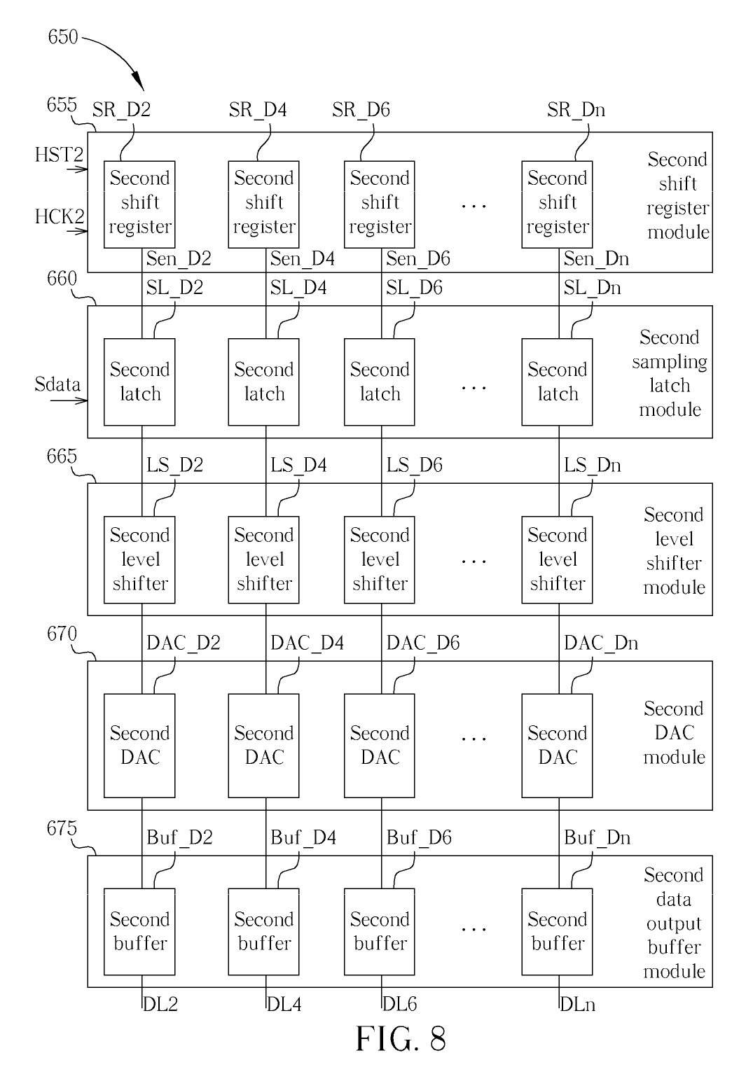

Referring to FIG. 8, there is shown a schematic diagram of the second source driver in FIG. 6 in accordance with an embodiment of the present invention. As shown in FIG. 8, the second shift register module 655 comprises a plurality of second shift registers SR_D2, SR_D4-SR_Dn. The second sampling latch module 660 comprises a plurality of second latches SL_D2, SL_D4-SL_Dn. The second level shifter module 665 comprises a plurality of second level shifters LS_D2, LS_D4-LS_Dn. The second digital-to-analog converter 670 comprises a plurality of second digital-to-analog converters DAC_D2, DAC_D4-DAC_Dn. The second data output buffer module 675 comprises a plurality of second buffers Buf_D2, Buf_D4-Buf_Dn.

Each second shift register is utilized for generating a corresponding second control signal. Each second shift register is coupled directly to a corresponding second latch for providing a corresponding second control signal to the corresponding second latch. For instance, the second shift register SR_D2 is coupled directly to the second latch SL_D2 for providing the second control signal Sen_D2 to the second latch SL_D2, and the second shift register SR_D4 is coupled directly to the second latch SL_D4 for providing the second control signal Sen_D4 to the second latch SL_D4. It is noted that the number of the second latches is substantially equal to the number of the second shift registers in the embodiment shown in FIG. 8. In the latching operation corresponding to each second latch of the second sampling latch module 660, two consecutive data signals are sequentially latched during an enable period of the second control signal, and the firstly-latched data signal is overwritten by the secondly-latched data signal so that only the even-order data signals of the image data signal Sdata are latched and the odd-order data signals of the image data signal Sdata are overwritten.

Each second level shifter is coupled to one corresponding second latch for performing a level shifting process on the corresponding even-order data signal of the image data signal Sdata. Each second digital-to-analog converter is coupled to one corresponding second level shifter for performing a digital-to-analog converting process on the corresponding even-order data signal of the image data signal Sdata. Each second buffer is coupled to one corresponding second digital-to-analog converter for performing a data output buffering process on the corresponding even-order data signal of the image data signal Sdata. Also, each second buffer is coupled to one corresponding even data line. For instance, the second buffer Buf_D2 is coupled between the second digital-to-analog converter DAC_D2 and the even data line DL2, and the second buffer Buf_D4 is coupled between the second digital-to-analog converter DAC_D4 and the even data line DL4.

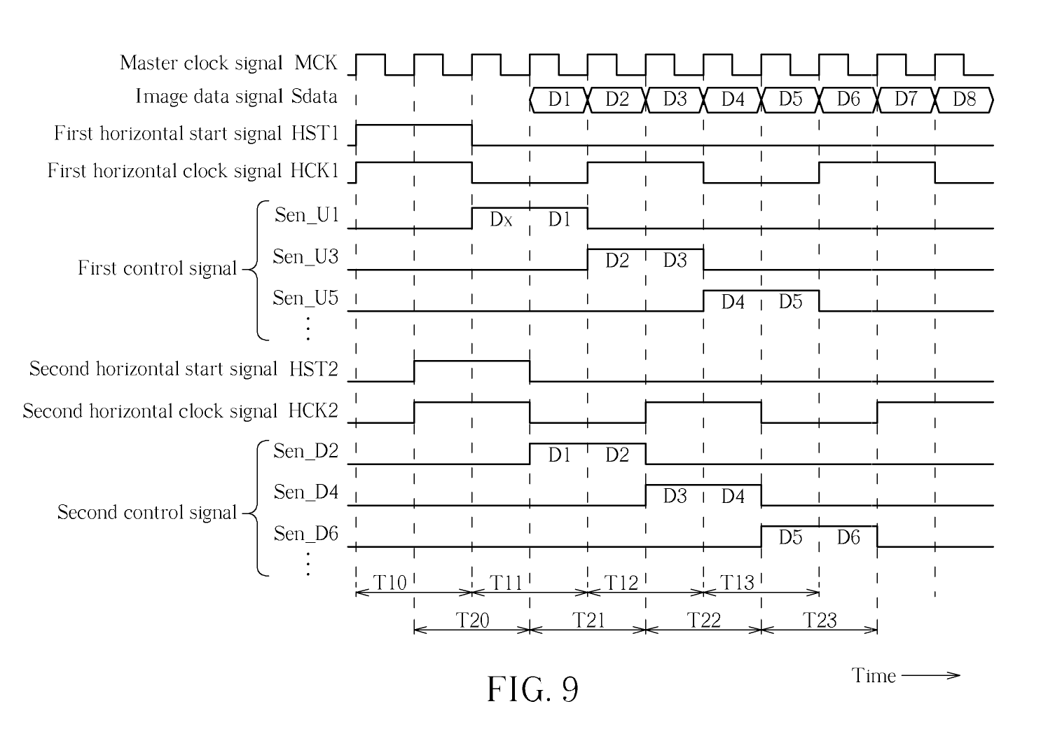

FIG. 9 is a timing diagram schematically showing the related signal waveforms concerning the operation of the LCD device in FIG. 6, having time along the abscissa. The signal waveforms in FIG. 9, from top to bottom, are the master clock signal MCK, the image data signal Sdata, the first horizontal start signal HST1, the first horizontal clock signal HCK1, the plurality of first control signals, the second horizontal start signal HST2, the second horizontal clock signal HCK2, and the plurality of second control signals. The image data signal Sdata comprises a plurality of data signals D1, D2, D3, etc. After a start pulse of the first horizontal start signal HST1 is furnished to the first shift register module 625 during the time T10, the first control signals are sequentially enabled based on the first horizontal clock signal HCK1. Each enable period of the first control signals is corresponding to a half period of the first horizontal clock signal HCK1. During each enable period of the first control signals, two consecutive data signals are sequentially latched, and the firstly-latched data signal is overwritten by the secondly-latched data signal so that only the odd-order data signals of the image data signal Sdata are latched and the even-order data signals of the image data signal Sdata are overwritten.

For instance, when the first shift register SR_U1 forwards the enabled first control signal Sen_U1 to the first latch SL_U1 during the time T11, the first latch SL_U1 will sequentially latch the virtual data signal Dx and the odd-order data signal D1. Accordingly, the odd-order data signal D1 is latched in the first latch SL_UL after the time T11 in that the virtual data signal Dx is overwritten by the odd-order data signal D1.

When the first shift register SR_U3 forwards the enabled first control signal Sen_U3 to the first latch SL_U3 during the time T12, the first latch SL_U3 will sequentially latch the even-order data signal D2 and the odd-order data signal D3. Accordingly, the odd-order data signal D3 is latched in the first latch SL_U3 after the time T12 in that the even-order data signal D2 is overwritten by the odd-order data signal D3.

When the first shift register SR_U5 forwards the enabled first control signal Sen_U5 to the first latch SL_U5 during the time T13, the first latch SL_U5 will sequentially latch the even-order data signal D4 and the odd-order data signal D5. Accordingly, the odd-order data signal D5 is latched in the first latch SL_U5 after the time T13 in that the even-order data signal D4 is overwritten by the odd-order data signal D5. Other similar operations concerning other first latches during other times can be inferred accordingly. That is, only the odd-order data signals are latched in the plurality of first latches SL_U1, SL_U3-SL_Un−1.

After the odd-order data signals are latched, the plurality of first level shifters LS_U1, LS_U3-LS_Un−1 perform level shifting operations on the odd-order data signals, and the plurality of first digital-to-analog converters DAC_UL, DAC_U3-DAC_Un−1 perform digital-to-analog converting operations on the odd-order data signals for generating a plurality of first analog data signals. The plurality of first analog data signals are then forwarded to the odd data lines DL1, DL3-DLn−1 respectively via the plurality of first buffers Buf_U1, Buf_U3-Buf_Un−1 so that the plurality of first analog data signals can be written into corresponding pixel units 691.

After a start pulse of the second horizontal start signal HST2 is furnished to the second shift register module 655 during the time T20, the plurality of second control signals are sequentially enabled based on the second horizontal clock signal HCK2. Each enable period of the second control signals is corresponding to a half period of the second horizontal clock signal HCK2. During each enable period of the second control signals, two consecutive data signals are sequentially latched, and the firstly-latched data signal is overwritten by the secondly-latched data signal so that only the even-order data signals of the image data signal Sdata are latched and the odd-order data signals of the image data signal Sdata are overwritten.

For instance, when the second shift register SR_D2 forwards the enabled second control signal Sen_D2 to the second latch SL_D2 during the time T21, the second latch SL_D2 will sequentially latch the odd-order data signal D1 and the even-order data signal D2. Accordingly, the even-order data signal D2 is latched in the second latch SL_D2 after the time T21 in that the odd-order data signal D1 is overwritten by the even-order data signal D2.

When the second shift register SR_D4 forwards the enabled second control signal Sen_D4 to the second latch SL_D4 during the time T22, the second latch SL_D4 will sequentially latch the odd-order data signal D3 and the even-order data signal D4. Accordingly, the even-order data signal D4 is latched in the second latch SL_D4 after the time T22 in that the odd-order data signal D3 is overwritten by the even-order data signal D4.

When the second shift register SR_D6 forwards the enabled second control signal Sen_D6 to the second latch SL_D6 during the time T23, the second latch SL_D6 will sequentially latch the odd-order data signal D5 and the even-order data signal D6. Accordingly, the even-order data signal D6 is latched in the second latch SL_D6 after the time T23 in that the odd-order data signal D5 is overwritten by the even-order data signal D6. Other similar operations concerning other second latches during other times can be inferred accordingly. That is, only the even-order data signals are latched in the plurality of second latches SL_D2, SL_D4-SL_Dn.

After the even-order data signals are latched, the plurality of second level shifters LS_D2, LS_D4-LS_Dn perform level shifting operations on the even-order data signals, and the plurality of second digital-to-analog converters DAC_D2, DAC_D4-DAC_Dn perform digital-to-analog converting operations on the even-order data signals for generating a plurality of second analog data signals. The plurality of second analog data signals are then forwarded to the even data lines DL2, DL4-DLn respectively via the plurality of second buffers Buf_D2, Buf_D4-Buf_Dn so that the plurality of second analog data signals can be written into corresponding pixel units 691.

In summary, the costly data processing interface circuit is not required to be installed in the peripheral device area of the LCD device 600 of the present invention. That is, the input image data signal can be forwarded directly to both the first source driver 620 and the second source driver 650 for performing data writing operations without the aid of the data processing interface circuit. Accordingly, the LCD device 600 can be scaled down by reducing the peripheral device area, and furthermore the power consumption concerning the signal extracting and frequency down-converting processes can be put away in the operation of the LCD device 600.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A liquid crystal display device comprising:
a first set of data lines for receiving a first set of data signals;
a second set of data lines for receiving a second set of data signals;
a plurality of gate lines for receiving a plurality of gate signals;
a gate driver, electrically coupled to the plurality of gate lines, for providing the plurality of gate signals;
a first source driver electrically coupled to the first set of data lines, the first source driver being configured to transfer the first set of data signals to the first set of data lines after receiving the first set of data signals and the second set of data signals;
a second source driver electrically coupled to the second set of data lines, the second source driver being configured to transfer the second set of data signals to the second set of data lines after receiving the first set of data signals and the second set of data signals; and
a plurality of pixel units, each pixel unit being electrically coupled to a corresponding data line and a corresponding gate line.

2. The liquid crystal display device of claim 1, wherein:
the first source driver comprises:
a first shift register module for generating a plurality of first control signals based on a horizontal start signal and a horizontal clock signal, the first shift register module comprising:
a plurality of first shift registers, each first shift register being utilized for generating a corresponding first control signal; and
a first sampling latch module, electrically coupled to the first shift register module, for latching the first set of data signals based on the first control signals after receiving the first set of data signals and the second set of data signals, the first sampling latch module comprising:
a plurality of first latches, each first latch being electrically coupled to a corresponding first shift register having odd-order for latching a corresponding data signal of the first set of data signals based on a corresponding first control signal; and
the second source driver comprises:
a second shift register module for generating a plurality of second control signals based on the horizontal start signal and the horizontal clock signal, the second shift register module comprising:
a plurality of second shift registers, each second shift register being utilized for generating a corresponding second control signal; and
a second sampling latch module, electrically coupled to the second shift register module, for latching the second set of data signals based on the second control signals after receiving the first set of data signals and the second set of data signals, the second sampling latch module comprising:
a plurality of second latches, each second latch being electrically coupled to a corresponding second shift register having even-order for latching a corresponding data signal of the second set of data signals based on a corresponding second control signal.

3. The liquid crystal display device of claim 2, further comprising:
a clock controller, electrically coupled to the first shift register module and the second shift register module, for generating the horizontal start signal and the horizontal clock signal based on a master clock signal, a horizontal synchronous signal, or a vertical synchronous signal.

4. The liquid crystal display device of claim 2, wherein a number of the first latches is substantially equal to a half of a number of the first shift registers, and a number of the second latches is substantially equal to a half of a number of the second shift registers.

5. The liquid crystal display device of claim 2, wherein:
the first source driver further comprises:
a first level shifter module, electrically coupled to the first sampling latch module, for performing level shifting operations on the first set of data signals; and
the second source driver further comprises:
a second level shifter module, electrically coupled to the second sampling latch module, for performing level shifting operations on the second set of data signals.

6. The liquid crystal display device of claim 2, wherein:
the first source driver further comprises:
a first digital-to-analog converter module, electrically coupled to the first sampling latch module, for performing digital-to-analog converting operations on the first set of data signals; and
the second source driver further comprises:
a second digital-to-analog converter module, electrically coupled to the second sampling latch module, for performing digital-to-analog converting operations on the second set of data signals.

7. The liquid crystal display device of claim 6, wherein:
the first source driver further comprises:
a first data output buffer module, electrically coupled between the first digital-to-analog converter module and the first set of data lines, for performing data buffering operations on the first set of data signals; and
the second source driver further comprises:
a second data output buffer module, electrically coupled between the second digital-to-analog converter module and the second set of data lines, for performing data buffering operations on the second set of data signals.

8. A liquid crystal display device comprising:
a first set of data lines for receiving a first set of data signals;
a second set of data lines for receiving a second set of data signals;
a plurality of gate lines for receiving a plurality of gate signals;
a gate driver, electrically coupled to the plurality of gate lines, for providing the plurality of gate signals;
a clock controller for generating a first horizontal start signal, a first horizontal clock signal, a second horizontal start signal and a second horizontal clock signal based on a master clock signal, a horizontal synchronous signal or a vertical synchronous signal, the clock controller comprising:
a first output end for outputting the first horizontal start signal;
a second output end for outputting the first horizontal clock signal;
a third output end for outputting the second horizontal start signal; and
a fourth output end for outputting the second horizontal clock signal;
a first source driver, electrically coupled to the first and second ends of the clock controller for receiving the first horizontal start signal and the first horizontal clock signal, and electrically coupled to the first set of data lines, the first source driver being configured to transfer the first set of data signals to the first set of data lines based on the first horizontal start signal and the first horizontal clock signal after receiving the first set of data signals and the second set of data signals;
a second source driver, electrically coupled to the third and fourth ends of the clock controller for receiving the second horizontal start signal and the second horizontal clock signal, and electrically coupled to the second set of data lines, the second source driver being configured to transfer the second set of data signals to the second set of data lines based on the second horizontal start signal and the second horizontal clock signal after receiving the first set of data signals and the second set of data signals; and
a plurality of pixel units, each pixel unit being coupled to a corresponding data line and a corresponding gate line.

9. The liquid crystal display device of claim 8, wherein the clock controller comprises:
a first horizontal start signal generator, electrically coupled to the first output end of the clock controller, for generating the first horizontal start signal;
a first horizontal clock signal generator, electrically coupled to the second output end of the clock controller, for generating the first horizontal clock signal;
a second horizontal start signal generator, electrically coupled to the third output end of the clock controller, for generating the second horizontal start signal; and
a second horizontal clock signal generator, electrically coupled to the fourth output end of the clock controller, for generating the second horizontal clock signal;
wherein circuits of the first horizontal start signal generator, the first horizontal clock signal generator, the second horizontal start signal generator and the second horizontal clock signal generator may be partly overlapped.

10. The liquid crystal display device of claim 8, wherein:
the first source driver comprises:
a first shift register module for generating a plurality of first control signals based on the first horizontal start signal and the first horizontal clock signal, the first shift register module comprising:
a plurality of first shift registers, each first shift register being utilized for generating a corresponding first control signal; and
a first sampling latch module, electrically coupled to the first shift register module, for latching the first set of data signals based on the first control signals after receiving the first set of data signals and the second set of data signals, the first sampling latch module comprising:
a plurality of first latches, each first latch being coupled to a corresponding first shift register and being utilized for latching a corresponding data signal of the first set of data signals based on a corresponding first control signal; and
the second source driver comprises:
a second shift register module for generating a plurality of second control signals based on the second horizontal start signal and the second horizontal clock signal, the second shift register module comprising:
a plurality of second shift registers, each second shift register being utilized for generating a corresponding second control signal; and
a second sampling latch module, electrically coupled to the second shift register module, for latching the second set of data signals based on the second control signals after receiving the first set of data signals and the second set of data signals, the second sampling latch module comprising:
a plurality of second latches, each second latch being coupled to a corresponding second shift register and being utilized for latching a corresponding data signal of the second set of data signals based on a corresponding second control signal.

11. The liquid crystal display device of claim 10, wherein a number of the first latches is substantially equal to a number of the first shift registers, and a number of the second latches is substantially equal to a number of the second shift registers.

12. The liquid crystal display device of claim 10, wherein:
the first source driver further comprises:
a first level shifter module, electrically coupled to the first sampling latch module, for performing level shifting operations on the first set of data signals; and
the second source driver further comprises:
a second level shifter module, electrically coupled to the second sampling latch module, for performing level shifting operations on the second set of data signals.

13. The liquid crystal display device of claim 10, wherein:
the first source driver further comprises:
a first digital-to-analog converter module, electrically coupled to the first sampling latch module, for performing digital-to-analog converting operations on the first set of data signals; and
the second source driver further comprises:
a second digital-to-analog converter module, electrically coupled to the second sampling latch module, for performing digital-to-analog converting operations on the second set of data signals.

14. The liquid crystal display device of claim 13, wherein:
the first source driver further comprises:
a first data output buffer module, electrically coupled to the first digital-to-analog converter module, for performing data buffering operations on the first set of data signals; and
the second source driver further comprises:
a second data output buffer module, electrically coupled to the second digital-to-analog converter module, for performing data buffering operations on the second set of data signals.

15. A driving method for driving a liquid crystal display device having a first source driver and a second source driver, the driving method comprising:
furnishing a plurality of data signals to the first source driver and the second source driver, wherein the plurality of data signals comprises a first set of data signals and a second set of data signals;
transferring the first set of data signals to a plurality of first pixel units via the first source driver; and
transferring the second set of data signals to a plurality of second pixel units via the second source driver.

16. The driving method of claim 15, wherein transferring the first set of data signals to the plurality of first pixel units via the first source driver comprises:
generating a plurality of first control signals by the first source driver;
latching the first set of data signals based on a plurality of odd-order first control signals of the plurality of first control signals;
performing a signal processing process on the first set of data signals by the first source driver for generating a plurality of first analog data signals; and
outputting the plurality of first analog signals to the plurality of first pixel units by the first source driver.

17. The driving method of claim 16, wherein transferring the second set of data signals to the plurality of second pixel units via the second source driver comprises:
generating a plurality of second control signals by the second source driver;
latching the second set of data signals based on a plurality of even-order second control signals of the plurality of second control signals;
performing a signal processing process on the second set of data signals by the second source driver for generating a plurality of second analog data signals; and
outputting the plurality of second analog signals to the plurality of second pixel units by the second source driver.

18. The driving method of claim 17, wherein:
generating the plurality of first control signals by the first source driver comprises generating the plurality of first control signals based on a horizontal start signal and a horizontal clock signal by the first source driver; and
generating the plurality of second control signals by the second source driver comprises generating the plurality of second control signals based on the horizontal start signal and the horizontal clock signal by the second source driver.

19. The driving method of claim 18, further comprising:
generating the horizontal start signal and the horizontal clock signal based on a master clock signal, a horizontal synchronous signal, or a vertical synchronous signal.

20. The driving method of claim 17, wherein:
performing the signal processing process on the first set of data signals by the first source driver for generating the plurality of first analog data signals comprises performing a digital-to-analog converting process on the first set of data signals by the first source driver for generating the plurality of first analog data signals; and
performing the signal processing process on the second set of data signals by the second source driver for generating the plurality of second analog data signals comprises performing a digital-to-analog converting process on the second set of data signals by the second source driver for generating the plurality of second analog data signals.

21. The driving method of claim 17, wherein:
performing the signal processing process on the first set of data signals by the first source driver for generating the plurality of first analog data signals comprises performing level shifting and digital-to-analog converting processes on the first set of data signals by the first source driver for generating the plurality of first analog data signals; and
performing the signal processing process on the second set of data signals by the second source driver for generating the plurality of second analog data signals comprises performing level shifting and digital-to-analog converting processes on the second set of data signals by the second source driver for generating the plurality of second analog data signals.

22. A driving method for driving a liquid crystal display device having a first source driver and a second source driver, the driving method comprising:
furnishing a plurality of data signals to the first source driver and the second source driver;
generating a plurality of first control signals by the first source driver, and generating a plurality of second control signals by the second source driver;
performing a data-overwrite latching process on a plurality of odd-order data signals of the data signals based on the plurality of first control signals by the first source driver;
performing a data-overwrite latching process on a plurality of even-order data signals of the data signals based on the plurality of second control signals by the second source driver;
performing a signal processing process on the plurality of odd-order data signals by the first source driver for generating a plurality of first analog data signals;
performing a signal processing process on the plurality of even-order data signals by the second source driver for generating a plurality of second analog data signals;
outputting the plurality of first analog signals to a plurality of first pixel units by the first source driver; and
outputting the plurality of second analog signals to a plurality of second pixel units by the second source driver.

23. The driving method of claim 22, wherein:
generating the plurality of first control signals by the first source driver is generating the plurality of first control signals based on a first horizontal start signal and a first horizontal clock signal by the first source driver; and
generating the plurality of second control signals by the second source driver is generating the plurality of second control signals based on a second horizontal start signal and a second horizontal clock signal by the second source driver.

24. The driving method of claim 23, further comprising:
generating the first horizontal start signal, the first horizontal clock signal, the second horizontal start signal and the second horizontal clock signal based on a master clock signal, a horizontal synchronous signal, or a vertical synchronous signal.

25. The driving method of claim 22, wherein:
performing the signal processing process on the plurality of odd-order data signals by the first source driver for generating the plurality of first analog data signals comprises performing a digital-to-analog converting process on the plurality of odd-order data signals by the first source driver for generating the plurality of first analog data signals; and
performing the signal processing process on the plurality of even-order data signals by the second source driver for generating the plurality of second analog data signals comprises performing a digital-to-analog converting process on the plurality of even-order data signals by the second source driver for generating the plurality of second analog data signals.

26. The driving method of claim 22, wherein:
performing the signal processing process on the plurality of odd-order data signals by the first source driver for generating the plurality of first analog data signals comprises performing level shifting and digital-to-analog converting processes on the plurality of odd-order data signals by the first source driver for generating the plurality of first analog data signals; and
performing the signal processing process on the plurality of even-order data signals by the second source driver for generating the plurality of second analog data signals comprises performing level shifting and digital-to-analog converting processes on the plurality of even-order data signals by the second source driver for generating the plurality of second analog data signals.

27. The driving method of claim 22, wherein:
performing the data-overwrite latching process on the plurality of odd-order data signals of the data signals based on the plurality of first control signals by the first source driver comprises firstly latching a first data signal having even-order and secondly latching a second data signal having odd-order during an enable period of a latch of the first source driver based on a corresponding first control signal by the first source driver, wherein the first data signal and the second data signal are successive data signals, and the second data signal overwrites the first data signal; and
performing the data-overwrite latching process on the plurality of even-order data signals of the data signals based on the plurality of second control signals by the second source driver comprises firstly latching a third data signal having odd-order and secondly latching a fourth data signal having even-order during an enable period of a latch of the second source driver based on a corresponding second control signal by the second source driver, wherein the third data signal and the fourth data signal are successive data signals, and the fourth data signal overwrites the third data signal.

28. The driving method of claim 22, wherein:
performing the data-overwrite latching process on the plurality of odd-order data signals of the data signals based on the plurality of first control signals by the first source driver comprises firstly latching a virtual data signal and secondly latching a first-order data signal during an enable period of a latch of the first source driver based on a corresponding first control signal by the first source driver, wherein the first-order data signal overwrites the virtual data signal.
